(19) United States
(12) Patent Application Publication
(10) Pub. No.: US 2008/0236202 A1
(43) Pub. Date: Oct. 2, 2008

(54) Tunnel Furnace

(75) Inventor: Arvid Sorvik, Stjordal (NO)

Correspondence Address: DENNISON, SCHULTZ & MACDONALD, 1727 KING STREET, SUITE 105, ALEXANDRIA, VA, 22314, US

(73) Assignee: HAS HOLDING AS, Trondheim (NO)

(21) Appl. No.: 12/092,769

(22) PCT Filed: Nov. 15, 2006
(86) PCT No.: PCT/NO06/00416

§ 371 Date: Jun. 4, 2008

(30) Foreign Application Priority Data
Nov. 17, 2005 (NO) 20055451

(51) Int. Cl. C03B 19/08; C03B 11/00; C03B 3/02

(52) U.S. Cl. 65/274

(57) ABSTRACT

Tunnel furnace for foaming glass material, comprising heating elements chosen among electrical and gas based heating elements. The tunnel furnace comprises at least the following temperature zones: a preheating zone (8) suitable for heating the feed material to a temperature in the range 400-900° C. and a foaming zone (9) suitable for heating the glass material to a temperature above 900° C. The furnace also typically comprises a cooling zone (10) suitable for reducing the temperature from the elevated temperature in the foaming zone. According to the present invention the preheating zone (8) is at least 15% longer than the foaming zone (9).

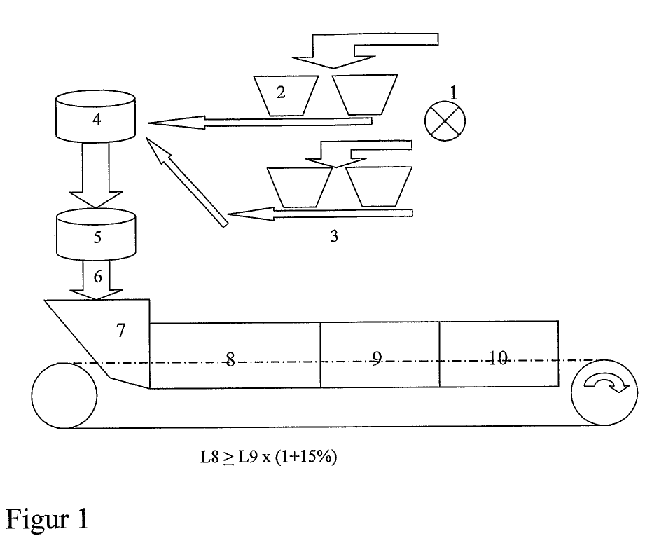

The present invention concerns a tunnel furnace and more particularly a tunnel furnace for production of foam glass granules as well as for other products and materials base don glass as raw material.

### BACKGROUND

It is desirable and a need for extensively to make use of recycle glass of different types to prevent it from being placed in land fills or other dump sites. AT the same time there is a need for lightweight, insulating materials in the building industry.

It is furthermore well known that glass can be used as an insulating material subsequent to being heated and foamed form a very lightweight and comparatively strong structure of closed pores separated by thin walls. It is, however, only certain types of glass that have proved suitable for the purpose and the foaming process is sensitive to contamination in the glass. It has thus been required with a high degree of grading of different types of glass and a correspondingly high degree of purification of the glass to ensure that the foaming can be conducted without problems.

A process according to proven technology is described in EP 0 292 424 B1. If e.g. lamp glass, which typically contain difficulty fusible glass in combination with foamable elements of glue, bakelite, plastic etc., to an extent of more than 5% by weight, is included in the process according to this patent, the process will not progress as desired as the foaming will be inadequate and uncontrolled with formation of large, irregular pores and non-reacted glass powder in the resulting material.

A furnace for the purpose is known from MISAPOR AG in Switzerland, Meraaker in Norway and Grossenhain in Germany, all supplied by MUT Advanced Heating GmbH and in Sjaak in Norway supplied by Jenaer Sclmeltztechnik Jodeit GmbH. These furnaces provide acceptable results when a high amount of glass material of the most appropriate quality is used, but with e.g. a combination of glass fractions as mentioned above exceeding 5% by weight these furnaces do not provide product of the desired quality unless the velocity of the conveyor band and thus the production capacity is significantly reduced. The same situation occurs if the glass raw material contains contaminations of ceramics, porcelain and stone (CPS) of more than 2% by weight of the glass.

### OBJECTIVES

It is thus an object of the present invention to provide a tunnel furnace which is suitable for in a most efficient manner to produce granulate foam glass also from raw materials containing (foam) glass from different sources.

It is furthermore an object of the present invention to provide a tunnel furnace which allows manufacture of a lightweight insulating material from glass and in particular recycle glass even when the recycle glass contains such amounts of lamp glass or contaminations of ceramics, porcelain, stone, plastic, paper, organic material or moisture that existing furnaces and existing processes do not yield desired product qualities.

It is furthermore an object of the present invention to provide a tunnel furnace that is insensitive to choice of glass material so that glass material with a higher degree of variation in composition and purity than what previously has been possible can be used, while maintaining or improving material properties and product quality.

### THE INVENTION

Said objectives are achieved by the present invention as defined by claim 1.

Preferred embodiments of the invention are disclosed by the dependent claims.

In tunnel furnace material is passed through at a constant velocity. By including a preheating zone removal of substantial amounts of impurities which would interfere with the foaming process if present in significant concentrations, is achieved.

In a tunnel furnace the material to be treated is typically transported through the furnace on a heat resistant, endless conveyor. By allowing the preheating zone to be longer than the foaming zone according to the present invention, the retention time in the preheating zone becomes longer than the retention time in the foaming zone. This implies that volatile fragments of the glass are evaporated before the temperature in the material reaches a level where sintering of the glass particles commences.

An example is when purified glass from electric lamps or fluorescent tubes is used. Such glass will contain fragments of bakelite, plastic, ceramic fragments and glues. With the furnace according to the present invention production quality as well as production capacity of the granulate foam glass can be maintained even with a content of such glass exceeding 5% by weight of the total glass content, e.g. an addition of 10% by weight or more of such glass.

Another example is use of recycle glass from households in which there usually is a content of ceramics, porcelain, stone and other undesired material (exceeding 2%) which leads to an uncontrolled pore formation in the glass. The alternative to an extended preheating zone is in this case an expensive preceding separation of the glass or reduced capacity as mentioned above.

When the tunnel furnace according to the present invention is used, comminuted recycle glass is subjected to a first treatment step at a temperature below 900° C., preferably in the range 500-700° C. At this separation step impurities in the form of calcium carbonates, plastic, or other hydrocarbon containing materials, paper, moisture and the like are evaporated or otherwise removed form the reaction mixture.

In the subsequent zone of the furnace the glass is foamed and to achieve foaming the temperature must be raised to at least above 900° C. In its simplest form this subsequent step is identical to the treatment in priory known processes and furnaces.

The glass material used as raw material in the present process can include glass from many different sources and will typically comprise glass chosen among window glass, laminated (white) glass, lamp glass, ceramic glass, CRT glass (used e.g. for TV screens) toughened glass and packaging glass. Packaging glass (bottle glass) should be present in an amount of at least 20% by weight of the total glass amount.

The temperature in the foaming zone is chosen or adapted to the composition of the recycle glass feed. If there is a high content of lamp glass and/or ceramic glass there is a need for a somewhat higher temperature in the second treatment step.

A typical retention time in the preheating zone is in the range 4 to 10 minutes while a typical retention time in the foaming zone is in the range 3 to 7 minutes. According to the present invention desired results are achieved when the preheating zone—and thus the retention time in this zone—is at least 15% longer than the foaming zone.

While the furnace mandatory comprises two zones as described above, it is preferred that is includes also a third zone which is arranged ahead of the preheating zone discussed above and can be denoted as a tempering zone. In the tempering zone the material is heated to a lower temperature than in the preheating zone ad typically to a temperature in the range 200 to 400° C. A further object of the tempering zone is to eliminate the most volatile impurities such as remains of plastic and paper, already before the material is subjected to treatment in the preheating zone.

What is particularly achieved with the tunnel furnace according to the invention is as mentioned the ability to use glass of a more varied origin without negatively affecting the process or the quality of the product. Furthermore a lower sensitivity to impurities in general is achieved since these are largely eliminated before the foaming step. The highest content of CPS (Ceramic, porcelain, stone) type impurities fed to the furnace until now is about 7% by weight, which yielded a fully satisfactory insulating material.

### DETAILED DESCRIPTION

An example of a furnace according to the present invention is given below with reference to the enclosed drawing.

In a crushing station 1 glass of different quality and origin is crushed and temporarily stored separate from other glass qualities and origins. Thereafter the crushed glass is portioned in weighing stations 2 and 3 to certain amounts/rates according to type and quality and mixed in grinding station 4 in which the glass is comminuted and sieved to desired grain size. From there the comminuted glass is transferred to a container 5 where a controlled amount of an activator is added and mixed with the comminuted glass until the mixture is homogenous. From container 5 the activated glass is transferred as a material flow 6 to a non-mandatory tempering zone 7 in which the glass is heated (tempered) to a temperature of about 400° C. From the tempering zone the tempered glass is transferred to the preheating zone 8 where it is heated further to a temperature in the range 500-700° C. In this zone the glass is retained typically for 4 to 10 minutes. The last active step in the process is the foaming which takes place in the foaming zone 9 to which the glass is directed from the preheating zone and heated further to a temperature in the range 900-1000° C. somewhat dependent upon the glass composition. The retention time in this step is about 3 to 7 minutes. Finally the glass granules are discharged from the foaming zone to a cooling zone 10 where it is allowed to cool to a temperature at first below 900° C. and thereafter typically to a temperature no higher than 300-400° C. In an industrial application it will always be required to cool the glass granules leaving the foaming zone. If this is done in a particular chamber in the furnace or in a separate chamber outside the furnace is not important.

The process taking place in the separate steps can be summarized as follows.

### Tempering

During the tempering 7 the most volatile, oxidizable or combustible impurities, such as paper and plastic materials, are eliminated from the feed mixture. Furthermore this step contributes to shorten the retention time in the preheating zone since the material has a comparatively high temperature already when entering the preheating zone.

### Preheating

During preheating 8 impurities i.a. of ceramics, porcelain and stone (CPS), containing materials which function as foaming activators at an undesired low temperature level and thus negatively will affect the quality of the end product if present during the foaming step, is eliminated.

### Foaming

In the foaming zone 8 the glass particles and foaming activators present are foamed to form a porous structure of glass with closed pores having a porosity in the range 65-87% and a density in the range 215-580 kg/m³. The foam glass typically has a compressive strength in the range 3-13 N/mm² and is capillary interrupted (water suction barrier), i.e. that it does not show any tendency to absorb water that is contacted with foamed glass.

The retention time in the preheating zone must be increased somewhat with increasing content of CPS impurities in the glass feed. It is not required with a proportional increase of retention time, though. For a CPS content of 1% a suitable retention time is proved to be about 5 minutes. If the CPS content is increased to 5%, i.e. an increase of 400%, the retention tie should be increased to 7 minutes, i.e. an increase of about 40%.

In practice it is convenient to assemble a tunnel furnace according to the present invention by means of modules so that furnaces of different length may be assembled from a few standardized building elements. It is furthermore convenient that the module elements have a defined basis length or a length that constitutes a multiple of such a basis length. A suitable basis length can e.g. be 32 cm.

In order to obtain a reasonable retention time for a suitable production capacity in an industrial plant it is convenient and preferred that the total length of the furnace is in the range 12-30 meters. A typical production rate is of magnitude 500 kg/hour. By the term “total length of the furnace” is meant the combined lengths of the tempering zone if present, the preheating zone, the foaming zone and the cooling zone. Preferred velocity of the conveyor is in the range 20-100 cm/minute.

1. Tunnel furnace for foaming of granulate glass material to foam-glass granules comprising hating elements chosen among electrical and gas based heating elements and combinations of such elements, comprising at least the following temperature zones:
a preheating zone (8) suitable for heating the glass feed material to a temperature in the range 400-900° C.,
a foaming zone (9) suitable for heating the glass material to a temperature above 900° C., characterized in that the preheating zone is at least 15% longer than the foaming zone (9).

2. Tunnel furnace as claimed in claim 1, characterized in that the walls of the furnace preheating zone (8) are made as module elements allowing assembly in varying lengths.

3. Tunnel furnace as claimed in claim 2, characterized in that the module elements are elements with a defined basis length or with a length constituting a multiple of a defined basis length.

4. Tunnel furnace as claimed in claim 3, characterized in that the defined basis length is about 32 centimetres.

5. Tunnel furnace as claimed in claim 1, characterized in that the furnace also comprises a tempering zone (7) arranged upstream of the preheating zone (8) and is arranged to temper the feed material to a temperature above 200° C., preferably to a temperature in the range 200-400° C.

6. Tunnel furnace as claimed in claim 1, characterized in that the furnace also comprises a cooling zone (10) arranged downstream of the foaming zone (9) and arranged to cool the foamed glass granules to a temperature above 200° C.

7. Tunnel furnace as claimed in claim 6, characterized in that the cooling zone (10) is arranged to cool the glass material to a temperature of about 400° C. before it leaves the furnace.

8. Tunnel furnace as claimed in claim 1, characterized in that it comprises an endless conveyor in a heat resistant material, arranged to transport the material through all furnace zones.

9. Tunnel furnace as claimed in claim 1, characterized in that the conveyor is arranged to move through the furnace zones with a velocity of 20 to 100 cm/minute.

10. Tunnel furnace as claimed in claim 1, characterized in that the total furnace length is in the range 12-30 meters.
